(19) United States
(12) Patent Application Publication
(10) Pub. No.: US 2021/0100406 A1
(43) Pub. Date: Apr. 8, 2021

(54) HAND SANITIZER SYSTEM FOR DRIVER

(71) Applicant: Toyota Motor Engineering & Manufacturing North America, Inc., Plano, TX (US)

(72) Inventor: Sergei I. Gage, Redford, MI (US)

(21) Appl. No.: 16/596,537

(22) Filed: Oct. 8, 2019

(51) Int. Cl. A47K 5/12; B60R 15/00; B60R 16/02

(52) U.S. Cl. CPC A47K 5/1217; B60R 16/02; B60R 15/00

(57) ABSTRACT

Methods, systems, devices and apparatuses for a hand sanitizing system. The hand sanitizing system includes a hand sanitizing dispenser. The hand sanitizing dispenser is positioned within the vehicle and configured to dispense a cleaning solution. The hand sanitizing dispenser includes a first sensor. The first sensor is configured to detect an amount of a substance on a hand of a user. The hand sanitizing system includes an electronic control unit. The electronic control unit is coupled to the hand sanitizing dispenser and the first sensor. The electronic control unit is configured to determine that the hand of the user is unclean based on the amount of the substance on the hand of the user. The electronic control unit is configured to activate the hand sanitizing dispenser to allow the hand sanitizing dispenser to dispense the cleaning solution.

### BACKGROUND

### Field

This disclosure relates to a system, method, apparatus and/or device for cleaning the hand of an occupant of a vehicle.

### Description of the Related Art

Often, an occupant of the vehicle will eat, drink or otherwise dirty their hands while driving and there is no soap or water available to clean their hands. The driver or passenger may be unable or unwilling to find a rest stop or other location to stop to find a restroom to wash their hands. And, even if the driver is able to find a rest stop or other location to stop to wash their hands, the driver must pull over to wash their hands, which is inconvenient to the other occupants and makes the road trip longer. For example, the driver may snack, eat, drink, fill-up gas or perform another activity, which may result in residue on their hands. And, the driver may wish to clean their hands without having to stop the vehicle or otherwise pull the vehicle over.

Accordingly, there is a need for a system, apparatus and/or method to dispense a cleaning solution within the vehicle to clean the hands of the driver, passengers and/or other users.

### SUMMARY

In general, one aspect of the subject matter described in this disclosure may be embodied in a hand sanitizing system for a vehicle. The hand sanitizing system includes a hand sanitizing dispenser. The hand sanitizing dispenser is positioned within the vehicle and configured to dispense a cleaning solution. The hand sanitizing dispenser includes a first sensor. The first sensor is configured to detect an amount of a substance on a hand of a user. The hand sanitizing system includes an electronic control unit. The electronic control unit is coupled to the hand sanitizing dispenser and the first sensor. The electronic control unit is configured to determine that the hand of the user is unclean based on the amount of the substance on the hand of the user. The electronic control unit is configured to activate the hand sanitizing dispenser to allow the hand sanitizing dispenser to dispense the cleaning solution.

These and other embodiments may optionally include one or more of the following features. The hand sanitizing dispenser may be positioned on a dashboard of the vehicle. The electronic control unit may be configured to determine that the amount of the substance on the hand of the user is greater than a threshold amount to determine that the hand of the user is unclean.

The hand sanitizing system may include a second sensor. The second sensor may be coupled to the hand sanitizing dispenser and may be configured to detect a presence of the hand of the user beneath the hand sanitizing dispenser. The electronic control unit may be configured to dispense the cleaning solution when the presence of the hand of the user is detected beneath the hand sanitizing dispenser. The hand sanitizing dispenser may have an indicator. The hand sanitizing dispenser may be configured to cause the indicator on the hand sanitizing dispenser to light when the hand sanitizing dispenser.

The hand sanitizing system may include a user interface. The user interface may be configured to output or notify the user. The electronic control unit may be configured to output an indicator that indicates to the user that the hand sanitizing dispenser is activated. The electronic control unit may be configured to dispense, using the hand sanitizing dispenser, a first amount of the cleaning solution when the amount of the substance on the hand of the user is a first amount of dirtiness and a second amount of the cleaning solution when the amount of the substance on the hand of the user is a second amount of dirtiness. The electronic control unit may be configured to dispense, using the hand sanitizing, an amount of cleaning solution that is directly proportional to the amount of the substance on the hand of the user.

In another aspect of the subject matter may be embodied in a hand sanitizing system. The hand sanitizing system includes a hand sanitizing dispenser. The hand sanitizing dispenser is configured to dispense a cleaning solution. The hand sanitizing system includes a first sensor and a second sensor. The first sensor is configured to detect an amount of a substance on a hand of a user. The second sensor is coupled to the hand sanitizing dispenser and configured to detect a presence of the hand of the user underneath the hand sanitizing dispenser. The hand sanitizing system includes a processor coupled to the hand sanitizing dispenser, the first sensor and the second sensor. The processor is configured to determine that the hand of the user is unclean based on the amount of the substance on the hand of the user. The processor is configured to activate the hand sanitizing dispenser to allow the hand sanitizing dispenser to dispense the cleaning solution. The processor is configured to dispense, using the hand sanitizing dispenser, the cleaning solution when the hand of the user is detected underneath the hand sanitizing dispenser and when the hand sanitizing dispenser is activated.

In another aspect, the subject matter may be embodied in a method for sanitizing a hand of a user. The method includes detecting, by an electronic control unit using a first sensor, an amount of a. substance on a hand of a user. The method includes determining, by the electronic control unit, that the hand of the user is unclean based on the amount of the substance on the hand of the user. The method includes activating, by the electronic control unit, the hand sanitizing dispenser to allow the hand sanitizing dispenser to dispense a cleaning solution.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 is a block diagram of an example hand sanitizing system according to an aspect of the invention.

FIG. 2 shows an example hand sanitizing dispenser of the hand sanitizing system of FIG. 1 according to an aspect of the invention.

FIG. 3A shows an example sensor and the hand sanitizing dispenser of the hand sanitizing system of FIG. 1 according to an aspect of the invention.

FIG. 3B shows an example sensor of the hand sanitizing system of FIG. 1 positioned on a door handle of the vehicle according to an aspect of the invention.

FIG. 4 is a flow diagram of an example process for dispensing the cleaning solution using the hand sanitizing system of FIG. 1 according to an aspect of the invention.

FIG. 5 is a flow diagram of an example process for determining the amount of cleaning solution to dispense using the hand sanitizing system of FIG. 1 according to an aspect of the invention.

### DETAILED DESCRIPTION

Disclosed herein are systems, apparatuses, and methods for sanitizing a hand of a driver and/or a passenger of a vehicle while driving. The hand sanitizing system detects when the hand of a driver or a passenger is dirty, sticky or otherwise unclean and activates a hand sanitizing dispenser. The hand sanitizing dispenser dispenses a cleaning solution when the hand of the user is underneath the hand sanitizing dispenser or in the dispersal path of the cleaning solution so that the driver and/or the passenger of the vehicle may use the cleaning solution to clean, wash or otherwise sanitize their hands. Particular embodiments of the subject matter described in this disclosure may be implemented to realize one or more of the following advantages. The hand sanitizing system detects when the hands of the driver and/or the passenger of the vehicle are dirty, sticky or otherwise unclean. The hand sanitizing system dispenses a cleaning solution so that the driver and/or the passenger may sanitize their hands even while driving, and thus, the driver and/or the passenger have clean hands and do not need to stop the vehicle to clean their hands.

Other benefits and advantages include the capability to ensure that the hand of the driver and/or the passenger is underneath the hand sanitizing dispenser when the cleaning solution is dispensed. This ensure that the cleaning solution is not unintentionally and/or inadvertently dispensed. Moreover, the hand sanitizing system may detect the amount of particulates, substance and/or residue (hereinafter, referred to as “substance”) on the hand of the driver and/or the passenger and dispense a corresponding amount of cleaning solution. This ensures that the hand sanitizing system does not dispense too much or too little cleaning solution to sanitize the hand of the driver and/or passenger, which minimizes waste.

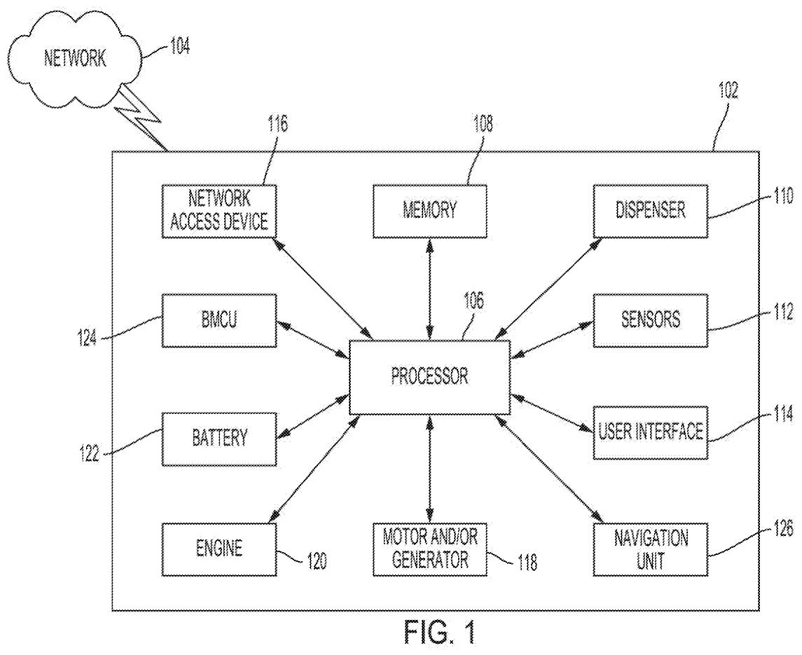

FIG. 1 is a block diagram of a hand sanitizing system 100. The hand sanitizing system 100 may be retro-fitted, coupled to, integrated with, include or be included within a vehicle 102 or may be entirely separate from the vehicle 102. The hand sanitizing system 100 may have or use a network 104 to communicate among different components of the hand sanitizing system 100. The network 104 may be a Dedicated Short-Range Communication (DSRC) network, a local area network (LAN), a wide area network (WAN), a cellular network, the Internet, or combination thereof, that connects, couples and/or otherwise communicates among the different components of the hand sanitizing system 100.

The hand sanitizing system 100 detects when the hands of a user are dirty, sticky or otherwise unclean. When the hands of the user are dirty, sticky or otherwise unclean, the hand sanitizing system 100 will dispense a cleaning solution 204 on the hand of the user. The cleaning solution 204 may be a sanitizing gel, water, soap and/or liquid or gel that sanitizes the hand of the user. In some implementations, the hand sanitizing system 100 may not necessarily dispense a cleaning solution, but rather, the hand sanitizing system 100 may activate a light, such as an ultraviolet (UV) light that sanitizes or sterilizes the hand of the user. This allows a user to clean their hands in the vehicle 102 without having to stop.

The hand sanitizing system 100 may include or be retro-fitter or integrated with the vehicle 102. A vehicle 102 is a conveyance capable of transporting a person, an object, or a permanently or temporarily affixed apparatus. The vehicle 102 may be a self-propelled wheeled conveyance, such as a car, sports utility vehicle, truck, bus, van or other motor, battery or fuel cell driven vehicle. For example, the vehicle 102 may be an electric vehicle, a hybrid vehicle, a hydrogen fuel cell vehicle, a plug-in hybrid vehicle or any other type of vehicle that has a fuel cell stack, a motor and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The hand sanitizing system 100 includes one or more processors 106, such as an electronic control unit, a memory 108, a hand sanitizing dispenser 110 and/or one or more sensors 112. The hand sanitizing system 100 may include a user interface 114 and/or a network access device 116. The hand sanitizing system 100 may be coupled to or include other vehicle components of the vehicle 102, such as a navigation unit 126, a motor and/or generator 118, an engine 120, a battery 122 and/or a battery management control unit 124. The hand sanitizing system 100 may not necessarily include the other vehicle components, but rather, the hand sanitizing system 100 may be coupled to the other vehicle components.

The one or more processors 106 may be an electronic control unit (ECU) and may be implemented as a single processor or as multiple processors. The one or more processors 106 may be electrically coupled to some or all the other components within the vehicles 102. The one or more processors 106 may include one or more controllers that detect substances and/or residue on a hand of the user and dispenses a cleaning solution 204 to clean the hands of the user. The one or more processors 106 may be coupled to a memory 108 and execute instructions that are stored in the memory 108.

The hand sanitizing system 100 has a memory 108. The memory 108 may be coupled to the one or more processors 106 and store instructions that the one or more processors executes. The memory 108 may include one or more of a Random Access Memory (RAM), Read Only Memory (ROM) or other volatile or non-volatile memory. The memory 108 may be a non-transitory memory or a data storage device, such as a hard disk drive, a solid-state disk drive, a hybrid disk drive, or other appropriate data storage, and may further store machine-readable instructions, which may be loaded and executed by the one or more processors 106.

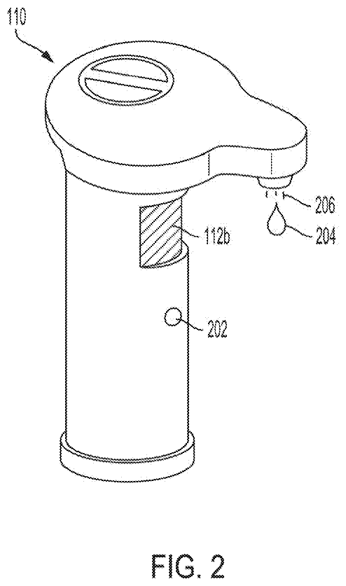

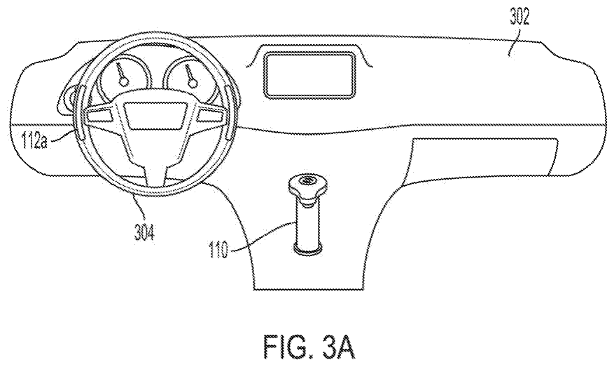

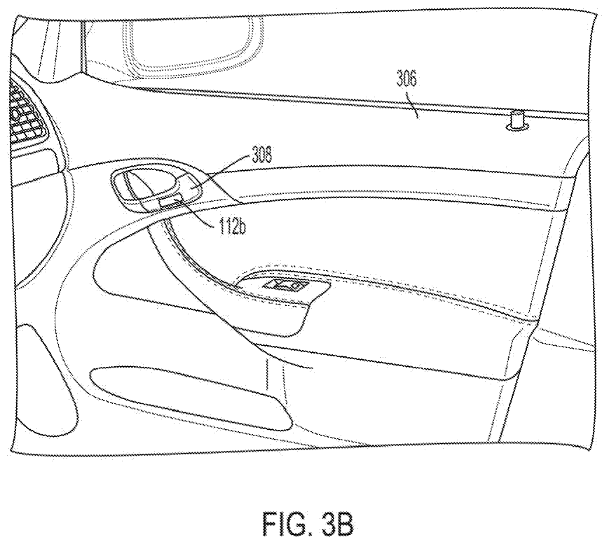

The hand sanitizing system 100 includes a hand sanitizing dispenser 110. The hand sanitizing dispenser 110 is coupled to the processor 106 and one or more sensors 112. FIG. 2 shows an example hand sanitizing dispenser 110. The hand sanitizing system 100 may include multiple hand sanitizing dispensers 110 each in a different position within the vehicle 102. The hand sanitizing dispenser 110 may be positioned on a center console between the seats, such as the center console between the rear seats equidistant between the rear passengers, and/or on a center portion of the dashboard 302 equidistant between the passenger seat and the driver seat so that the hand sanitizing dispenser 110 is equidistant between the driver and the passenger when the driver and passenger are seated, as shown in FIG. 3A for example. The hand sanitizing dispenser 110 dispenses the cleaning solution 204 to clean the hand of the user.

The one or more sensors 112, such as a substance detection sensor 112a and/or a hand detection sensor 112b, may be positioned on a steering wheel 304 of the vehicle 102 or on a door handle 308 of the vehicle 102, as shown in FIG. 3B for example, respectively. The one or more sensors 112 may include multiple different types of sensors. For example, the one or more sensors 112, such as the substance detection sensor 112a, may detect an amount of particulates on a hand of the user. In another example, the one or more sensors 112, such as the hand detection sensor 112b, may detect the presence or lack of presence of the hand of the user within a proximity of the one or more sensors 112. In some implementations, the hand detection sensor 112b that detects the presence or lack of presence of the hand of the user may be coupled or positioned on the hand sanitizing dispenser 110 to detect the presence or lack of presence of the hand underneath the hand sanitizing dispenser 110. The hand detection sensor 112b may be an optical sensor, for example, that detects that the hand of the user is in the dispersal path of the cleaning solution if the cleaning solution were to be dispensed.

The hand sanitizing system 100 may have a user interface 114 and/or a network access device 116. The hand sanitizing system 100 may receive user input via the user interface 114. For example, the user interface 114 may receive user input, such as a login/password or other user credential, which identifies the driver of the vehicle 102. The user interface 114 may be used to confirm the activation of the hand sanitizing dispenser 110.

The user interface 114 may include an input/output device that receives user input from a user interface element, a button, a dial, a microphone, a keyboard, or a touch screen. The user interface 114 may provide an output to an output device, such as a display, a speaker, an audio and/or visual indicator, or a refreshable braille display. The output device may display an alert or notification that the hand sanitizing dispenser 110 has been activated.

The network access device 116 may include a communication port or channel, such as one or more of a Dedicated Short-Range Communication (DSRC) unit, a Wi-Fi unit, a Bluetooth® unit, a radio frequency identification (RFID) tag or reader, or a cellular network unit for accessing a cellular network (such as 3G, 4G or 5G). The network access device 116 may transmit data to and receive data from the different components of the hand sanitizing system 100 including the one or more sensors 112, the hand sanitizing dispenser 110 and/or the processor 106.

The one or more vehicle components may include a navigation unit 126. The navigation unit 126 may be integral to the vehicle 102 or a separate unit coupled to the vehicle 102. The vehicle 102 may include a Global Positioning System (GPS) unit (not shown) for detecting location data including a current location of the vehicle 102 and date/time information instead of the navigation unit 126. In that regard, the processor 106 may perform the functions of the navigation unit 126 based on data received from the GPS unit. The navigation unit 126, or the processor 106 may perform navigation functions. Navigation functions may include, for example, route and route set prediction, providing navigation instructions, and receiving user input such as verification of predicted routes and route sets or destinations.

The one or more vehicle components may include a motor and/or generator 118. The motor and/or generator 118 may convert electrical energy into mechanical power, such as torque, and may convert mechanical power into electrical energy. The motor and/or generator 118 may be coupled to the battery 122. The motor and/or generator 118 may convert the energy from the battery 122 into mechanical power, and may provide energy back to the battery 122, for example, via regenerative braking. The vehicle 102 may include one or more additional power generation devices such as the engine 120 or a fuel cell stack (not shown). The engine 120 combusts fuel to provide power instead of and/or in addition to the power supplied by the motor and/or generator 118.

The battery 122 may be coupled to the motor and/or generator 118 and may provide electrical energy to and receive electrical energy from the motor and/or generator 118. The battery 122 may include one or more rechargeable batteries.

The BMCU 124 may be coupled to the battery 122 and may control and manage the charging and discharging of the battery 122. The BMCU 124, for example, may measure, using battery sensors, parameters used to determine the state of charge (SOC) of the battery 122. The BMCU 124 may control the battery 122.

FIG. 2 shows the hand sanitizing dispenser 110. The hand sanitizing dispenser 110 may have a hand detection sensor 112b that detects the presence or lack of presence of the hand of the user within the dispersal path 206 of the cleaning solution 204. The hand sanitizing dispenser may have an indicator 202, which lights or activates when the hand sanitizing dispenser 110 is activated, turned on or unlocked.

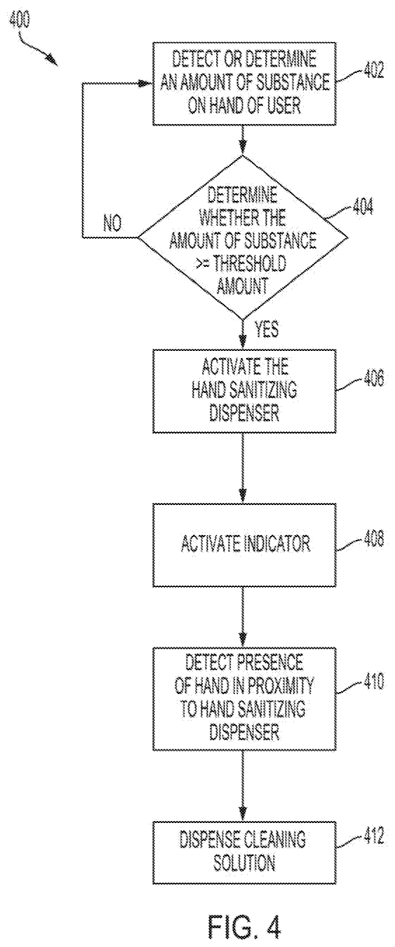

FIG. 4 is a flow diagram of a process 400 for dispensing a cleaning solution to clean the hands of an occupant of the vehicle 102. One or more computers or one or more data processing apparatuses, for example, the processor 106 of the hand sanitizing system 100 of FIG. 1, appropriately programmed, may implement the process 400.

The hand sanitizing dispenser 110 may be in a locked state, a deactivated state or an off state prior to being activated, turned on or unlocked. When the hand sanitizing dispenser is in the locked state, the hand sanitizing dispenser is powered on but is prevented from dispensing the cleaning solution 204. When in the deactivated or the off state, the hand sanitizing dispenser 110 does not have power.

The hand sanitizing system 100 may detect or determine an amount of a substance on a hand of the user (402). The user may be a driver, passenger or other occupant of the vehicle 102. The hand sanitizing system 100 may have one or more sensors 112 that are positioned on a steering wheel 304 of the vehicle 102, as shown in FIG. 3A for example, that measure the amount of substance on the hand of a driver when the driver positions their hands on the steering wheel 304 to drive, for example. The hand sanitizing system 100 may have one or more sensors 112 that are positioned on the door handle 308 of the door 306 of the vehicle 102, as shown in FIG. 3B for example, that measure the amount of substance on the hand of an occupant of the vehicle 102, when the occupant grabs the door handle 308 of the door 306 of the vehicle 102 to open or close the door 306 of the vehicle 102 to enter or exit the vehicle 102.

The one or more sensors 112 may measure or determine the amount of the substance on the hand by measuring a level of adenosine triphosphate (ATP) on the surface of the hand. The measure or level of ATP is a biological indicator that shows the amount of organic matter, dead or alive, which is on a surface. ATP is an enzyme that is present in all cells and the amount can be measured. For example, the one or more sensors 112 may be a camera may capture image data and analyze the image data to determine the amount of the substance on the hand. In another example, the one or more sensors 112 may be a sensor on the steering wheel 304 or other part of the vehicle 102, which may use spectroscopy, to determine surface characteristics including the amount of particulates on the hand of the user when the hand of the user is placed on the sensor.

The hand sanitizing system 100 may determine whether the amount of the substance on the hand of the user is greater than or equal to a threshold amount (404). The threshold amount may be determined and/or user-configured. The threshold amount may represent an amount of dirtiness or uncleanliness of the hand that when exceeded is unacceptable. For example, the threshold amount may be approximately 0.001-0.01 grams per square centimeter.

In some implementations, the threshold amount may also represent a baseline or average amount of dirtiness or uncleanliness of the hand that when exceeded is unacceptable. For example, the memory 108 may store the amount of substance on the hand of the user each time that the hand of the user is placed on the one or more sensors 112 and the processor 106 may take an average of the stored amounts. On a subsequence placement of the hand on the one or more sensors 112, the processor 106 may compare the current measurement of the amount of the substance on the hand of the user to the average of the stored amounts.

If the hand sanitizing system 100 determines that the amount of the substance is less than the threshold amount, the hand sanitizing system 100 continues to monitor, detect or determine the amount of substance on the hand of the user (402). If the hand sanitizing system 100 determines that the amount of the substance is greater than or equal to the threshold amount, the hand sanitizing system 100 may activate, turn on or unlock the hand sanitizing dispenser 110 (406). When the hand sanitizing dispenser 110 is unlocked, turned on or activated, the hand sanitizing dispenser 110 allows the cleaning solution 204 to be dispensed. This allows the hand sanitizing dispenser 110 to dispense the cleaning solution 204 when the hand of the user is placed in a position in the path of the cleaning solution 204. When the hand sanitizing dispenser 110 is unlocked, turned on or activated, the hand sanitizing dispenser 110 may dispense the cleaning solution 204 when the hand of the user is placed underneath a nozzle of the hand sanitizing dispenser 110, as shown in FIG. 2 for example.

The hand sanitizing system 100 may turn on, switch on or otherwise activate an indicator 202 to indicate to the user that the hand sanitizing dispenser 110 is activated (408). The indicator 202 may be an audio indicator and/or a visual indicator, such as a light emitting diode (LED) or other light on the hand sanitizing dispenser 110. In some implementations, the hand sanitizing system 100 may cause an indicator or a notification to display on the user interface 114 that notifies the user that the hand sanitizing dispenser is activated, turned on and/or unlocked. The indicator or the notification may suggest to the user to use the hand sanitizing dispenser to clean their hands, for example.

Once the hand sanitizing dispenser 110 is activated, the hand sanitizing system 100 may use one or more sensors 112 to detect the presence of the hand of the user in proximity to the hand sanitizing dispenser 110 (410). The one or more sensors 112 may be positioned on the hand sanitizing dispenser 110 and in proximity to the dispersal path 206 of the cleaning solution 204. This allows the one or more sensors 112 to detect the presence or lack of presence of the hand or other body part of the user in the dispersal path 206 of the cleaning solution 204 before the hand sanitizing dispenser 110 dispenses the cleaning solution 204.

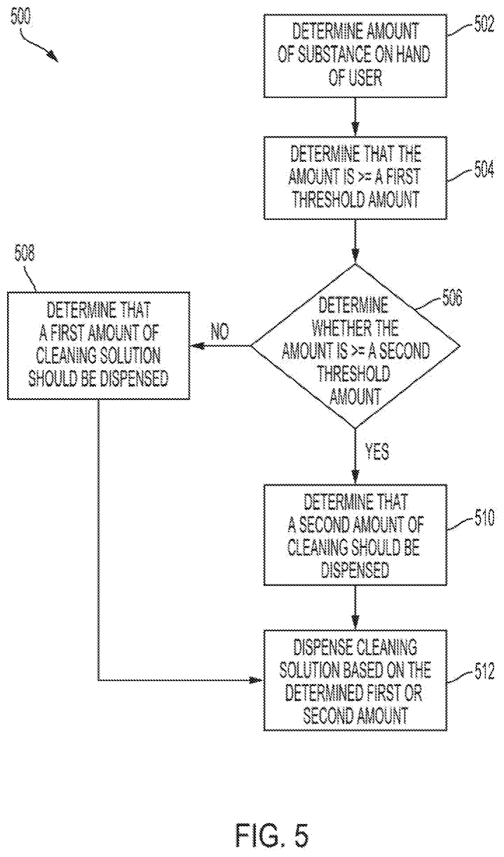

After the hand sanitizing dispenser 110 has been activated and the hand of the user is detected in proximity to the hand sanitizing dispenser 110, the hand sanitizing dispenser 110 dispenses the cleaning solution 204 (412). The hand sanitizing dispenser 110 may dispense the cleaning solution 204 along the dispersal path 206 onto the hand of the user or other body surface, which allows the user to clean their hands or other body surface. The amount of cleaning solution that the hand sanitizing dispenser 110 dispenses may be based on the amount of substance on the hand of the user. FIG. 5 further describes the amount of substance on the hand of the user that the hand sanitizing dispenser 110 dispenses.

FIG. 5 is a flow diagram of a process 500 for controlling the amount of cleaning solution that is dispensed on the hand of the user. One or more computers or one or more data processing apparatuses, for example, the processor 106 of the hand sanitizing system 100 of FIG. 1, appropriately programmed, may implement the process 500. The hand sanitizing system 100 may dispense different amount of cleaning solution 204 based on the amount of substance on the hand of the user. This allows the hand sanitizing system 100 to dispense enough cleaning solution 204 to clean the hands of the user, but limit the amount of cleaning solution 204 dispensed to avoid waste.

The hand sanitizing system 100 detects or determines an amount of a substance or residue on a hand of the user, as described above (502). The one or more sensors 112 may measure the amount of the substance on the hand of the user, such as the amount of substance per square area.

The hand sanitizing system 100 determines that the amount of the substance is greater or equal to a first threshold (504). When the amount of the substance is greater than or equal to the first threshold, the hand sanitizing system 100 unlocks, turns on or activates the hand sanitizing dispenser 110. The hand sanitizing system 100 determines whether the amount of the substance is greater than or equal to a second threshold (506). The second threshold is greater than the first threshold.

When the hand sanitizing system 100 determines that the amount of the substance on the hand of the user is less than the second threshold, the hand sanitizing dispenser 110 determines that a first amount of cleaning solution 204 should be dispensed (508). When the hand sanitizing system 100 determines that the amount of substance on the hand of the user is greater than or equal to the second threshold, the hand sanitizing dispenser 110 determines that a second amount, which may be greater than the first amount, of the cleaning solution 204 should be dispensed (510). The amount of cleaning solution dispensed may be directly proportional to the amount of the substance on the hand of the user.

Once the amount of cleaning solution 204 to be dispensed is determined, the hand sanitizing system 100 may dispense the cleaning solution 204 when the hand of the user is detected in proximity to the hand sanitizing dispenser 110 and in the dispersal path 206 of the cleaning solution 204, as described above (512). The amount dispensed may be either the first amount or the second amount. The hand sanitizing system 100 dispenses the first amount when the amount of substance is greater than or equal to the first threshold but less than the second threshold, and the hand sanitizing system 100 dispenses the second amount when the amount of substance is greater than or equal to the first and second threshold.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. A hand sanitizing system for a vehicle, comprising:
a hand sanitizing dispenser positioned within the vehicle and configured to dispense a cleaning solution;
a first sensor configured to detect an amount of a substance on a hand of a user; and
an electronic control unit coupled to the hand sanitizing dispenser and the first sensor and configured to:
determine that the hand of the user is unclean based on the amount of the substance on the hand of the user, and
activate the hand sanitizing dispenser to allow the hand sanitizing dispenser to dispense the cleaning solution automatically in response to the amount of the substance on the hand of the user being greater than a threshold amount.

2. The hand sanitizing system of claim 1, wherein the hand sanitizing dispenser is positioned on a dashboard of the vehicle.

3. The hand sanitizing system of claim 1, wherein to determine that the hand of the user is unclean, the electronic control unit is configured to determine that the amount of the substance on the hand of the user is greater than the threshold amount.

4. The hand sanitizing system of claim 1, further comprising:
a second sensor coupled to the hand sanitizing dispenser and configured to detect a presence of the hand of the user beneath the hand sanitizing dispenser;
wherein the electronic control unit is configured to:
dispense the cleaning solution when the presence of the hand of the user is detected beneath the hand sanitizing dispenser.

5. The hand sanitizing system of claim 1, wherein the hand sanitizing dispenser has an indicator, wherein the electronic control unit is configured to:
cause the indicator on the hand sanitizing dispenser to light when the hand sanitizing dispenser is activated.

6. The hand sanitizing system of claim 1, further comprising:
a user interface configured to output or notify the user;
wherein the electronic control unit is configured to:
output an indicator that indicates to the user that the hand sanitizing dispenser is activated.

7. The hand sanitizing system of claim 1, wherein the electronic control unit is configured to:
dispense, using the hand sanitizing dispenser, a first amount of the cleaning solution when the amount of the substance on the hand of the user is a first amount of dirtiness and a second amount of the cleaning solution when the amount of the substance on the hand of the user is a second amount of dirtiness.

8. The hand sanitizing system of claim 1, wherein the electronic control unit is configured to:
dispense, using the hand sanitizing dispenser, an amount of cleaning solution that is directly proportional to the amount of the substance on the hand of the user.

9. A hand sanitizing system, comprising:
a hand sanitizing dispenser configured to dispense a cleaning solution;
a first sensor configured to detect an amount of a substance on a hand of a user;
a second sensor coupled to the hand sanitizing dispenser and configured to detect a presence of the hand of the user underneath the hand sanitizing dispenser; and
a processor coupled to the hand sanitizing dispenser, the first sensor and the second sensor, the processor being configured to:
determine that the hand of the user is unclean based on the amount of the substance on the hand of the user,
activate the hand sanitizing dispenser to allow the hand sanitizing dispenser to dispense the cleaning solution automatically in response to the amount of the substance on the hand of the user being greater than a threshold amount, and
dispense, using the hand sanitizing dispenser, the cleaning solution when the hand of the user is detected underneath the hand sanitizing dispenser and when the hand sanitizing dispenser is activated.

10. The hand sanitizing system of claim 9, wherein to dispense the cleaning solution the processor is configured to:
dispense, using the hand sanitizing dispenser, a first amount of the cleaning solution when the amount of the substance on the hand of the user is a first amount of dirtiness and a second amount of the cleaning solution when the amount of the substance on the hand of the user is a second amount of dirtiness.

11. The hand sanitizing system of claim 9, wherein to dispense the cleaning solution the processor is configured to:
dispense an amount of cleaning solution that is directly proportional to the amount of the substance on the hand of the user.

12. The hand sanitizing system of claim 9, wherein the hand sanitizing dispenser has an indicator, wherein the processor is configured to:
cause the indicator on the hand sanitizing dispenser to light when the hand sanitizing dispenser is activated.

13. The hand sanitizing system of claim 9, further comprising:
a user interface configured to output or notify the user;
wherein the processor is configured to:
output an indicator that indicates to the user the hand sanitizing dispenser is activated.

14. The hand sanitizing system of claim 9, wherein the hand sanitizing dispenser is positioned on a dashboard of a vehicle.

15. The hand sanitizing system of claim 9, wherein to determine that the hand of the user is unclean, the processor is configured to determine that the amount of the substance on the hand of the user is greater than the threshold amount.

16. A method for sanitizing a hand of a user, comprising:
detecting, by an electronic control unit using a first sensor, an amount of a substance on a hand of a user;
and
automatically activating, by the electronic control unit, a hand sanitizing dispenser to allow the hand sanitizing dispenser to dispense a cleaning solution in response to the amount of the substance on the hand of the user being greater than a threshold amount.

17. The method of claim 16, further comprising:
dispensing, using the hand sanitizing dispenser, a first amount of the cleaning solution when the amount of the substance on the hand of the user is a first amount of dirtiness and a second amount of the cleaning solution when the amount of the substance on the hand of the user is a second amount of dirtiness.

18. The method of claim 16, further comprising
dispensing, using the hand sanitizing dispenser, an amount of the cleaning solution that is directly proportional to the amount of the substance on the hand of the user.

19. The method of claim 16, further comprising:
outputting an indicator that indicates that the hand sanitizing dispenser is activated.

20. The method of claim 16, further comprising:
determining that the amount of the substance on the hand of the user is greater than the threshold amount.
